(19) United States
(12) Patent Application Publication
(10) Pub. No.: US 2002/0049636 A1
(43) Pub. Date: Apr. 25, 2002

(54) System and method for generating and transmitting data keys to facilitate delivery, pick-up and other commercial transactions

(76) Inventors: Carter H. Griffin, Washington, DC (US); Robert Rekrutiak, Arlington, VA (US); Steven Van Till, Columbia, MD (US)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 09/832,331

(22) Filed: Apr. 11, 2001

Related U.S. Application Data
(60) Provisional application No. 60/196,087, filed on Apr. 11, 2000.
(60) Provisional application No. 60/209,594, filed on Jun. 6, 2000.

(51) Int. Cl. G06F 17/60

(52) U.S. Cl. 705/26

(57) ABSTRACT

A method for conducting commercial transactions is described. The method includes the steps of generating a data key in response to a request from a user and transmitting the data key to the user. The method also includes the step of transmitting the data key to a first remote location, in which the data key identifies a commercial transaction conducted by the user and also is stored at the first remote location. A system for conducting commercial transactions is described. The system includes a software program for generating a data key in response to a request from a user and a first hardware device for transmitting the data key to the user. The system also includes a second hardware device for transmitting the data key to a first remote location and a memory for storing the transmitted data key at the first remote location, in which the data key identifies a commercial transaction conducted by the user.

The present application claims priority from U.S. Provisional Patent Application No. 60/196,087, entitled “System and Method for Generating and Transmitting Data Keys to Facilitate Delivery, Pick-Up and other Commercial Transactions,” and U.S. Provisional Patent Application No. 60/209,594, entitled “System and Method for Generating and Transmitting Data Keys to Facilitate Delivery, Pick-Up and other Commercial Transactions,” the disclosures of which are incorporated herein by reference in their entirety.

### BACKGROUND OF THE INVENTION

1. Field of the Invention

The invention relates generally to the field of commercial transactions. More specifically, the invention is directed towards systems and methods for conducting commercial transactions involving the generation of unique data keys, which identify a particular transaction.

2. Description of Related Art

Consumers today are busier than ever and are challenged to find a sustainable balance between work and family. As a result, consumers have shown a strong willingness to embrace innovations that bring convenience and flexibility to their lives. Two trends that illustrate this phenomenon are (a) telecommuting and other home-based work situations, and (b) convenience-driven self-service devices and utilities. It is estimated that there are over 10 million workers in the United States who telecommute (i.e., work from home rather than travel to their office to work) more than one day per week. That figure is in addition to the more than 24 million Americans who operate businesses from their homes. It has been estimated that 40 million U.S. households are connected to the Internet at home, and nearly half of these homes use the Internet to purchase goods and services.

Moreover, once goods are purchased, they may be delivered at a remote location. One method of facilitating the delivery of goods at a remote location may be to use an unattended delivery system, such as that described in U.S. Pat. No. 5,774,053, the disclosure of which is incorporated herein by reference in its entirety. The system disclosed in U.S. Pat. No. 5,774,053 may provide a secure enclosure that may enable both inbound delivery and outbound pickup. Similarly, an unattended delivery storage device, such as that described in U.S. Provisional Patent Application No. 60/161,922, filed Oct. 28, 1999, the disclosure of which is incorporated herein by reference in its entirety, may be used.

### SUMMARY OF THE INVENTION

Therefore, a need has arisen for a system and method that overcomes these and other shortcomings of the related art. A technical advantage of the present invention is that a consumer may purchase an item, either in person or from a remote location, and may have the item securely transmitted for delivery at a particular location, without the consumer having to be present at the location. Another technical advantage of the present invention is that a consumer may securely return or transmit an item from a first location to a second location without having to be present at the first location when a shipping agent picks up the item for transmission.

According to an embodiment of the present invention, a method for conducting commercial transactions is described. The method comprises the steps of generating a data key in response to a request from at least one user and transmitting the data key to the at least one user. The method also comprises the step of transmitting the data key to a first remote location, in which the data key identifies at least one commercial transaction conducted by the user and also is stored at the first remote location.

In another embodiment of the present invention, a method for conducting commercial transactions is described. The method comprises the steps of conducting at least one commercial transaction with a user, receiving at least one generated data key from the user, in which the data key identifies the commercial transaction, and transmitting the data key to a shipping agent.

In yet another embodiment of the present invention, a method for conducting commercial transactions is described. The method comprises the steps of receiving at least one data key identifying at least one item purchased by a user and receiving the item purchased by the user. The method also comprises the steps of transmitting the data key to a first remote location and transmitting the item to a remote location when the data key matches a data key previously stored at the first remote location.

In still yet another embodiment of the present invention, a method for conducting commercial transactions is described. The method comprises the steps of receiving at least one data key, in which the data key identifies at least one item for pick-up requested by a user, and transmitting the first data key to a first remote location. The method also comprises the steps of retrieving the item when the data key matches a data key previously stored at the first remote location and transmitting the item from the first location to a second location.

In a further embodiment of the present invention, a method for conducting commercial transactions is described. The method comprises the steps of generating a data key in response to a request from at least one user, transmitting the data key to the user, and purchasing at least one item, in which the data key identifies the item. The method also comprises the steps of transmitting the data key and the item to a shipping agent, transmitting and storing the data key at a remote location and transmitting the data key to the remote location. The method further comprises the step of transmitting the item to the remote location when the data key matches the data key stored at the remote location.

In still a further embodiment of the present invention, a system for conducting commercial transactions is described. The system comprises a software program for generating a data key in response to a request from at least one user and a first hardware device for transmitting the data key to the user. The system also comprises a second hardware device for transmitting the data key to a first remote location and a memory for storing the transmitted data key at the first remote location, in which the data key identifies at least one commercial transaction conducted by the user.

Other objects, features, and advantages will be apparent to persons of ordinary skill in the art in view of the following detailed description of the invention and the accompanying drawings.

### BRIEF DESCRIPTION OF THE DRAWINGS

For a more complete understanding of the present invention, the needs satisfied thereby, and the features and advantages thereof, reference now is made to the following descriptions taken in connection with accompanying drawings.

FIGS. 1A-1D are schematics of a system for conducting commercial transactions according to an embodiment of the present invention.

FIGS. 2A-2B are flow charts of a method for conducting commercial transactions according to an embodiment of the present invention.

FIGS. 3A-3B are flow charts of a method for conducting commercial transactions according to an embodiment of the present invention.

FIGS. 4A-4B are flow charts of a method for conducting commercial transactions according to an embodiment of the present invention.

FIGS. 5A-5B are flow charts of a method for conducting commercial transactions according to an embodiment of the present invention.

FIG. 6 is a flow chart of a method for conducting commercial transactions according to an embodiment of the present invention.

### DETAILED DESCRIPTION OF PREFERRED EMBODIMENTS

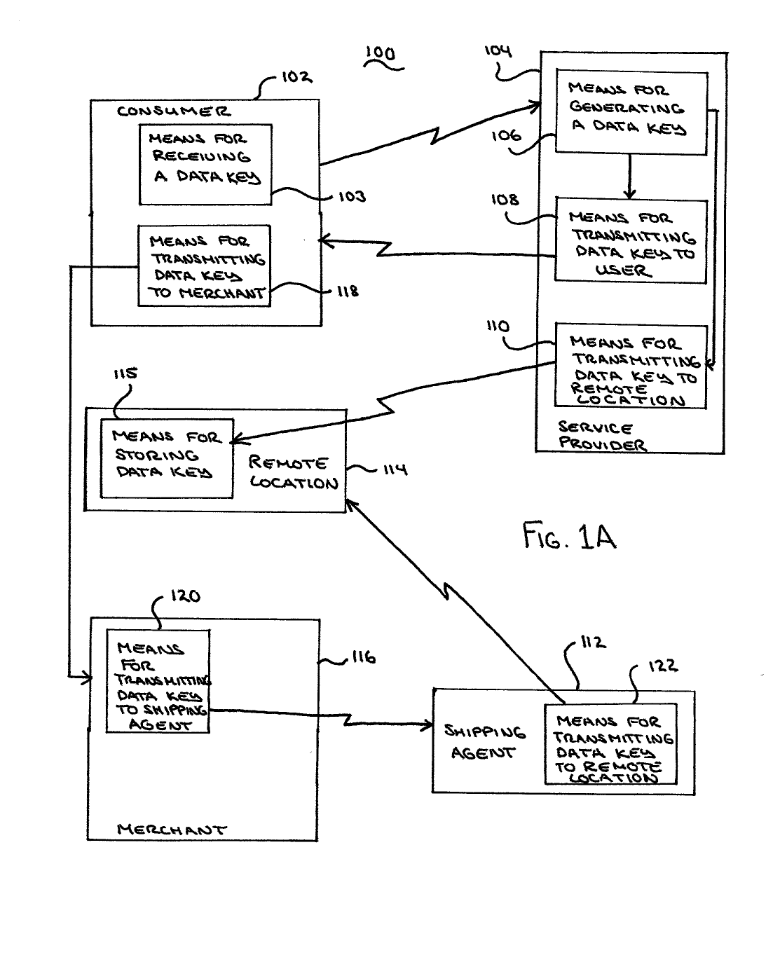

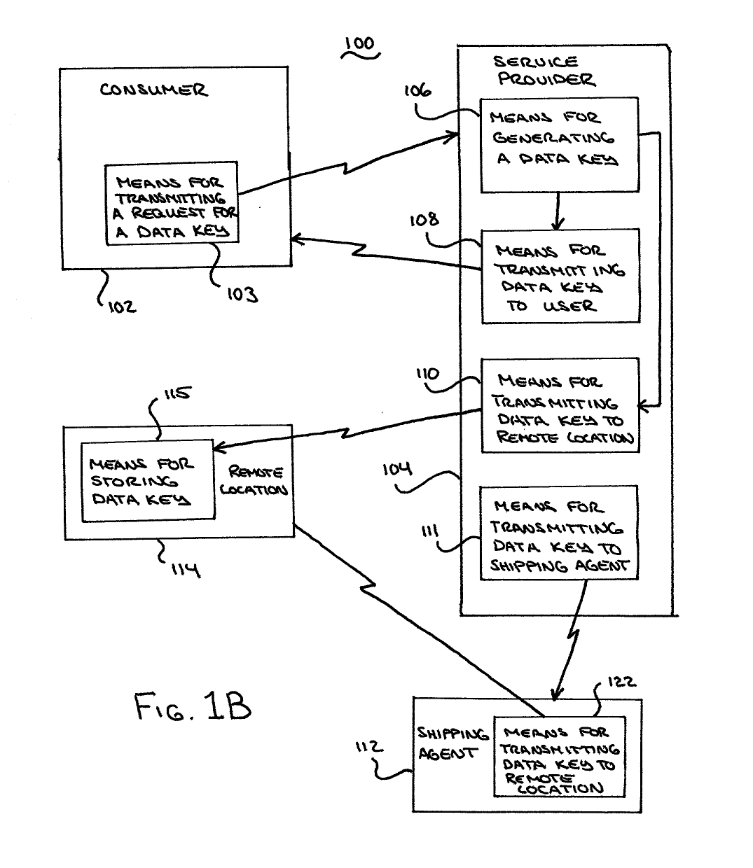

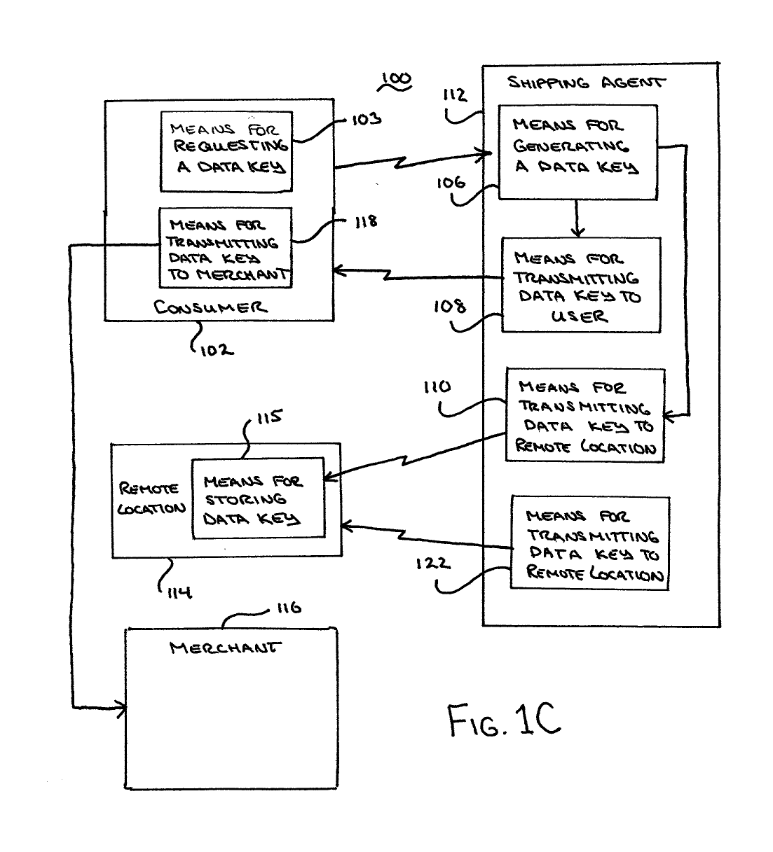

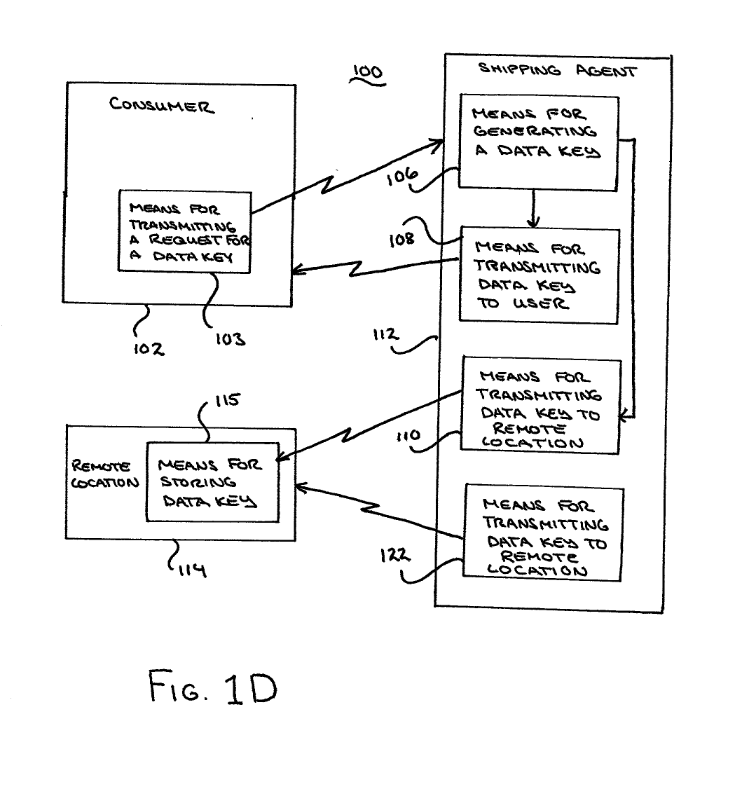

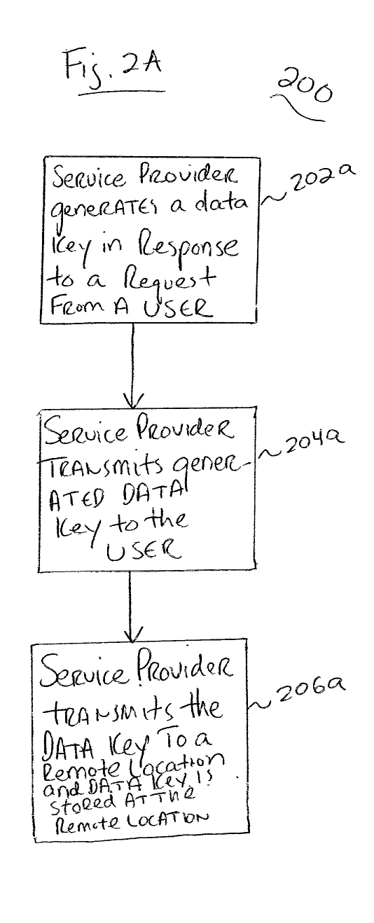

Preferred embodiments of the present invention and their advantages may be understood by referring to FIGS. 1-6, like numerals being used for like corresponding parts in the various drawings.

Referring to FIGS. 1A and 1B, a system 100 for conducting commercial transactions is described. In an embodiment of the present invention, system 100 may be used by a consumer or a user 102. Consumer 102 may employ means for requesting a data key 103, which may be a first hardware device. The first hardware device may be a computer, such as a personal computer, an office computer, a public use computer, or the like. In another embodiment, the first hardware device may be a telephone, such as a home or business telephone, a mobile telephone, a personal digital assistant, a two-way paging system, or the like. Consumer 102 may use the first hardware device to contact a service provider 104 and also may request that service provider 104 generate a data key. Moreover, service provider 104 may employ means for generating a data key 106, which may be a software program. For example, in an embodiment, the software program may be similar to the software program described in Appendix A of U.S. Provisional Patent Application No. 60/196,087, the disclosure of which was previously incorporated by reference. The software program may be accessed by consumer 102 via an internet web-site. Alternatively, consumer 102 may contact a representative of service provider 104, and the representative may access the software program in response to the request for a data key. Moreover, the data key be alphanumeric or may be numeric, and also may be generated randomly, sequentially, logically, or the like.

Service provider 104 also may employ means for transmitting the generated data key 108 to a user, which may be a second hardware device. The second hardware device may be a computer, such as a personal computer, an office computer, a public use computer, or the like. The second hardware device may be a telephone, such as a home or business telephone, a mobile telephone, a personal digital assistant, a two-way paging system, or the like. Service provider 104 may use the second hardware device to transmit the data key to consumer 102. Alternatively, service provider 104 also may employ means for transmitting the data key to a remote location 114, which may be a third hardware device. The third hardware device may be a computer, such as a personal computer, an office computer, a public use computer, or the like. The third hardware device may be a telephone, such as a home or business telephone, a mobile telephone, a personal digital assistant, a two-way paging system, or the like. Service provider 104 may use the third hardware device to transmit the data key to remote location 114. Moreover, in an embodiment, the first, second, and third hardware devices may be the same device.

Remote location 114 may include means for storing the data key 115. For example, remote location 114 may be an unattended storage device or the like. In this embodiment, means for storing the data key 115 may be a memory located inside the storage device. Alternatively, remote location 114 may be an attended location, such as an apartment complex attended by a monitor, or the like. In this embodiment, the third hardware device may transmit the data key to the monitor, who then may record the transmission in a transmission log, or the like. The monitor also may transmit the data key to a memory, such as a memory of a computer or a memory of a storage device located at remote location 114, or the like.

Referring to FIG. 1A, in an embodiment of the present invention, the commercial transaction conducted by consumer 102 may be a purchase of at least one item. In this embodiment, system 100 may be employed by a merchant 116 and by consumer 102 who may purchase the item from merchant 116. Consumer 102 may purchase the item remotely, such as over the telephone, via an Internet web-site, or the like, or may purchase the item in person. When the purchase is completed remotely, consumer 102 may employ means for transmitting the data key 118 to merchant 116, which may be a fourth hardware device. The fourth hardware device may be a computer, such as a personal computer, an office computer, a public use computer, or the like.

Consumer 102 may locate merchant 116's web-site and select at least one item for purchase. Merchant 116 then may request that consumer 102 enter user data, such as consumer 102's name, address, telephone number, or the like. Consumer 102 may transmit the data key to merchant 116 by entering the data key into an “Address Line 2” field, or the like. The fourth hardware device may be a telephone, such as a home or business telephone, a mobile telephone, a personal digital assistant, a two-way paging system, or the like. Alternatively, when the purchase is done in person, consumer 102 may verbally transmit the data key to merchant 116 or may transmit the data key in writing, and merchant 116 may record the data key. For example, the data key may be recorded on a sales order form or may be entered into a computer system. Moreover, in each of the above described embodiments, the data key may identify the at least one item purchased by consumer 102. In addition, merchant 116 further may employ means for transmitting the data key 120 to a shipping agent 112, which means may be a package identifier and the package identifier may include the data key. For example, merchant 116 may package the item and may generate the package identifier. Merchant 116 also may affix the package identifier to the package. The package identifier may be an alphanumeric string, a bar code, an RF ID tag, means for encoding data on a physical package, or the like. In this embodiment, once the package identifier is affixed to the package, the package may be transmitted to shipping agent 112 for delivery. The package may be transmitted to shipping agent 112 using any known method of transmitting a package, such as depositing the package in a drop box of shipping company 112, hand delivering the package to a representative of shipping agent 112, or the like.

Shipping agent 120 may employ means for transmitting the data key 122 to remote location 114. When remote location 114 is an unattended storage device, means 122 may be a key pad located on the storage device, in which shipping agent 112 may transmit the data key by pressing at least one key on the control pad. Alternatively, means 122 may be a data capture device, in which the data key may be scanned into the data capture device and electronically transmitted to the storage device. Moreover, shipping agent 112 may gain access to an interior of the storage device and also may transfer the package to the storage device when the transmitted data key matches the data key stored in the memory of the storage device. When remote location 114 is an attended location, shipping agent 112 may verbally transmit the data key to the monitor. The monitor then may compare the transmitted data key to the data key which the monitor previously received from service provider 104, and shipping agent 112 may transfer the package to the monitor when the transmitted data key matches the data key the monitor previously received from service provider 104.

Referring to FIG. 1B, in another embodiment of the present invention, the commercial transaction conducted by consumer 102 may be a request for a pick-up of at least one item, in which consumer 102 may transfer the item to remote location 114 for pick-up. In this embodiment, system 100 may be used by a shipping agent 112, and service provider 104 may employ means for transmitting the data key 111 to shipping agent 112, such as a fifth hardware device. The fifth hardware device may be a computer, such as a personal computer, an office computer, a public use computer, or the like. Alternatively, the fifth hardware device may be a telephone, such as a home or business telephone, a mobile telephone, a personal digital assistant, a two-way paging system, or the like. Moreover, in this embodiment, shipping agent 112 may employ means for transmitting the data key 122 to remote location 114. When remote location 114 is an unattended storage device, means 122 may be a key pad located on the storage device, in which shipping agent 112 may transmit the data key by pressing at least one key on the control pad. Moreover, means 122 may be a data capture device, in which the data key may be scanned into the data capture device and electronically transmitted to the unattended storage device. Moreover, shipping agent 112 may gain access to an interior of the storage device and also may retrieve the item located inside the storage device when the transmitted data key matches the data key stored in the memory of the storage device. Shipping agent 112 further may transfer the item from the storage device to a second remote location. When remote location 114 is an attended location, shipping agent 112 may verbally transmit the data key to the monitor. The monitor then may compare the transmitted data key to the data key which the monitor previously received from service provider 104, and shipping agent 112 may retrieve the item from the monitor when the transmitted data key matches the data key the monitor previously received from service provider 104. Shipping agent 112 further may transfer the item from the storage device to a second remote location.

Referring to FIGS. 1C and 1D, a system 100 for conducting commercial transactions according to another embodiment is described. In still another embodiment of the present invention, system 100 may be used by a consumer or a user 102. Consumer 102 may employ means for requesting a data key 103, which may be a first hardware device. The first hardware device may be a computer, such as a personal computer, an office computer, a public use computer, or the like. Alternatively, the first hardware device may be a telephone, such as a home or business telephone, a mobile telephone, a personal digital assistant, a two-way paging system, or the like. Consumer 102 may use the first hardware device to contact a shipping agent 112 and also may request that shipping agent 112 generate a data key. Moreover, shipping agent 112 may employ means for generating a data key 106, which may be a software program. For example, the software program may be similar to the software program described in Appendix A of U.S. Provisional Patent Application No. 60/196,087, the disclosure of which was previously incorporated by reference. The software program may be accessed by consumer 102 via an Internet web-site. Moreover, consumer 102 may contact a representative of shipping agent 112, and the representative may access the software program in response to the request for a data key. The data key be alphanumeric or may be numeric, and also may be generated randomly, sequentially, logically, or the like.

Shipping agent 112 also may employ means for transmitting the generated data key 108 to a user, which may be a second hardware device. The second hardware device may be a computer, such as a personal computer, an office computer, a public use computer, or the like. Alternatively, the second hardware device may be a telephone, such as a home or business telephone, a mobile telephone, a personal digital assistant, a two-way paging system, or the like. Shipping agent 112 may use the second hardware device to transmit the data key to consumer 102. Shipping agent 112 also may employ means for transmitting the data key to a remote location 114, which may be a third hardware device. The third hardware device may be a computer, such as a personal computer, an office computer, a public use computer, or the like. The third hardware device may be a telephone, such as a home or business telephone, a mobile telephone, a personal digital assistant, a two-way paging system, or the like. Shipping agent 112 may use the third hardware device to transmit the data key to remote location 114. Moreover, in an embodiment, the first, second, and third hardware devices may be the same device.

Remote location 114 may employ means for storing the data key 115. For example, remote location 114 may be an unattended storage device or the like. In this embodiment, means for storing the data key 115 may be a memory located inside the storage device. Alternatively, remote location 114 may be an attended location, such as an apartment complex attended by a monitor, or the like. In this embodiment, the third hardware device may transmit the data key to the monitor, who then may record the transmission in a transmission log, or the like. The monitor also may transmit the data key to a memory, such as a memory of a computer or a memory of a storage device located at remote location 114, or the like.

Referring to FIG. 1C, the commercial transaction conducted by consumer 102 may be a purchase of at least one item. In this embodiment, system 100 may be used by a merchant 116, and consumer 102 may purchase the item from merchant 116. Consumer 102 may purchase the item remotely, such as over the telephone, via an internet web-site, or the like, or may purchase the item in person. When the purchase is completed remotely, consumer 102 may employ means for transmitting the data key 118 to merchant 116, which may be a fourth hardware device. The fourth hardware device may be a computer, such as a personal computer, an office computer, a public use computer, or the like. In this embodiment, consumer 102 may locate merchant 116's web-site and select at least one item for purchase. Merchant 116 then may request that consumer 102 enter user data, such as consumer 102's name, address, telephone number, or the like. Consumer 102 may transmit the data key to merchant 116 by entering the data key into an “Address Line 2” field, or the like. Alternatively, the fourth hardware device may be a telephone, such as a home or business telephone, a mobile telephone, a personal digital assistant, a two-way paging system, or the like. Moreover, when the purchase is completed in person, consumer 102 may verbally transmit the data key to merchant 116 or may transmit the data key in writing, and merchant 116 may record the data key. The data key may be recorded on a sales order form or may be entered into a computer system. In addition, in each of the above described embodiments, the data key may identify the at least one item purchased by consumer 102. In addition merchant 116 may package the purchased item and also may transfer the package to shipping agent 112. In one embodiment, merchant 116 may generate a package identifier, which may include the data key, and also may affix the package identifier to the package to be shipped to shipping agent 112. The package identifier may be an alphanumeric string, a bar code, an RF ID tag, means for encoding data on a physical package, or the like. The package may be transmitted to shipping agent 112 using any known method of transmitting a package, such as depositing the package in a drop box of shipping company 112, hand delivering the package to a representative of shipping agent 112, or the like.

Shipping agent 120 may employ means for transmitting the data key 122 to remote location 114. When remote location 114 is an unattended storage device, means 122 may be a key pad located on the storage device, in which shipping agent 112 may transmit the data key by pressing at least one key on the control pad. Alternatively, means 122 may be a data capture device, in which the data key may be scanned into the data capture device and electronically transmitted to the storage device. Moreover, shipping agent 112 may gain access to an interior of the storage device and also may transfer the package to the storage device when the transmitted data key matches the data key stored in the memory of the storage device. When remote location 114 is an attended location, shipping agent 112 may verbally transmit the data key to the monitor. The monitor then may compare the transmitted data key to the data key which the monitor previously received from service provider 104, and shipping agent 112 may transfer the package to the monitor when the transmitted data key matches the data key the monitor previously received from service provider 104.

Referring to FIG. 1D, in yet another embodiment of the present invention, the commercial transaction conducted by consumer 102 may be a request for a pick-up of at least one item, in which consumer 102 may transfer the item to remote location 114 for pick-up. In this embodiment, system 100 may used by a shipping agent 112 and shipping agent 112 may employ means for transmitting the data key 122 to remote location 114. When remote location 114 is an unattended storage device, means 122 may be a key pad located on the storage device, in which shipping agent 112 may transmit the data key by pressing at least one key on the control pad. Alternatively, means 122 may be a data capture device, in which the data key may be scanned into the data capture device and electronically transmitted to the storage device. Moreover, shipping agent 112 may gain access to an interior of the storage device and also may retrieve the item located inside the storage device when the transmitted data key matches the data key stored in the memory of the storage device. Shipping agent 112 further may transfer the item from the storage device to a second remote location. When remote location 114 is an attended location, shipping agent 112 may verbally transmit the data key to the monitor. The monitor then may compare the transmitted data key to the data key which the monitor previously received from service provider 104, and shipping agent 112 may retrieve the item from the monitor when the transmitted data key matches the data key the monitor previously received from service provider 104. Shipping agent 112 further may transfer the item from the storage device to a second remote location.

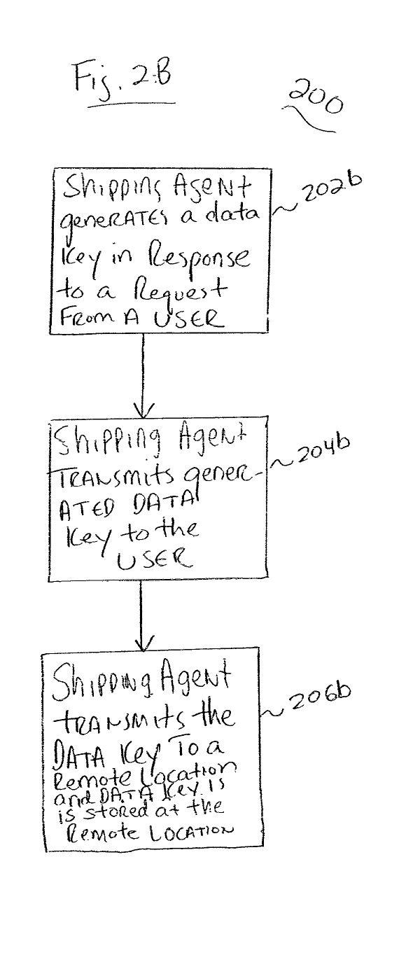

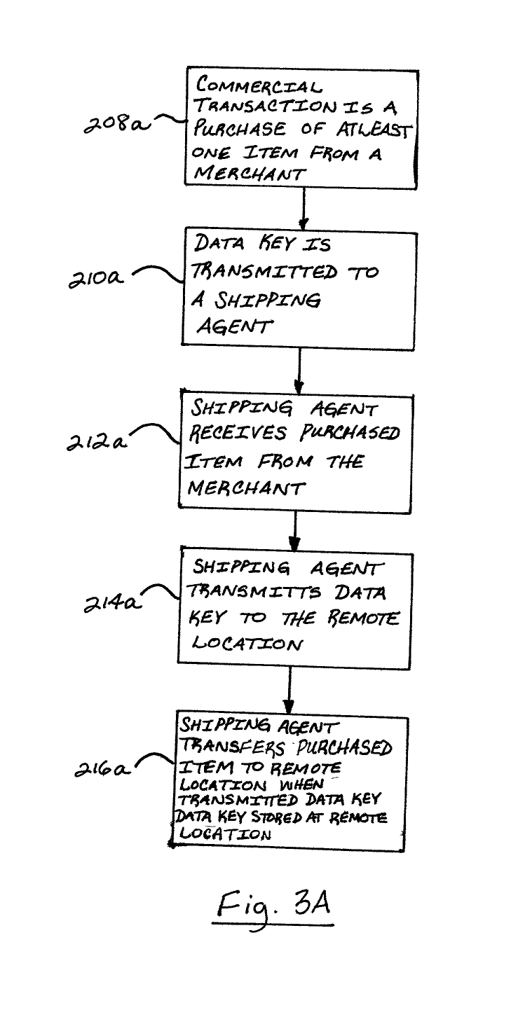

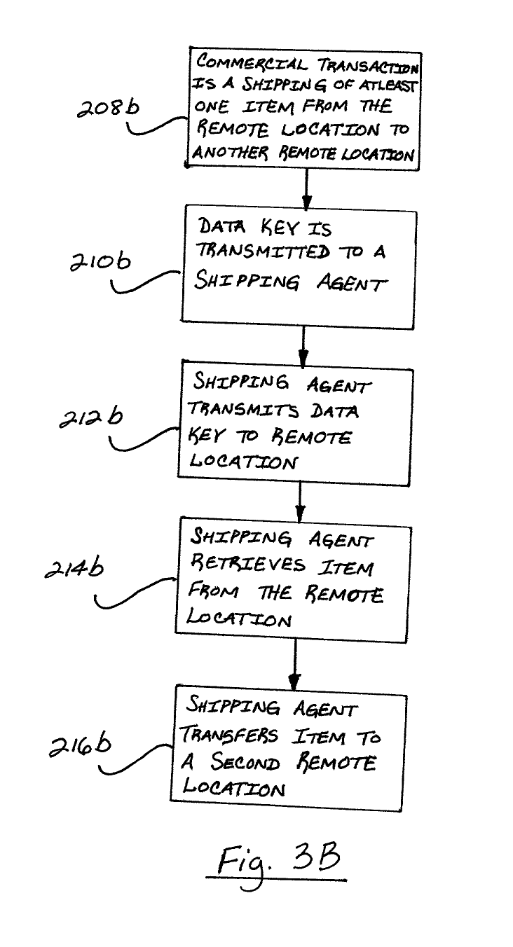

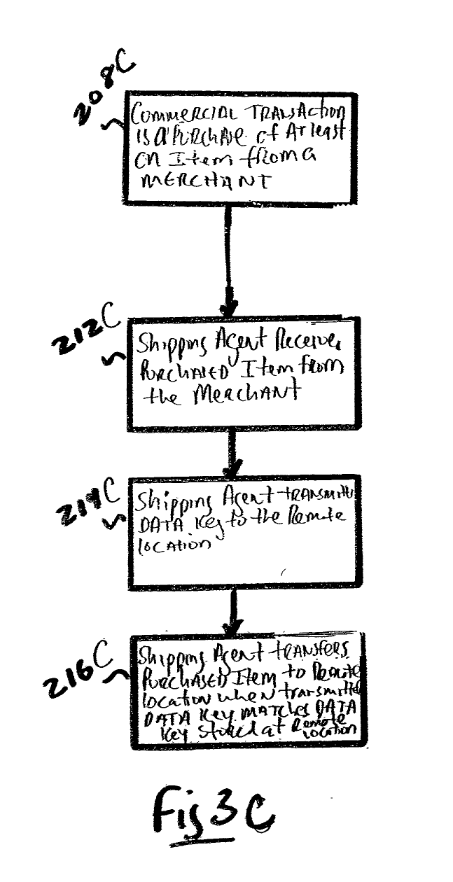

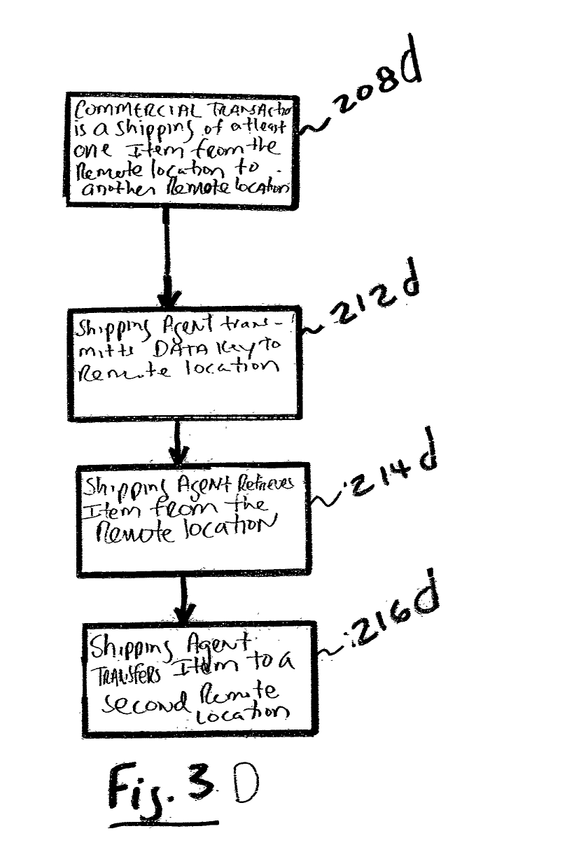

Referring to FIGS. 2A, 3A, and 3B, a method 200 for conducting commercial transactions according to another embodiment of the present invention is described. In step 202a, a service provider 104 may generate a data key in response to a request from a consumer or user 102. Consumer 102 may use a first hardware device to request the data key. The first hardware device may be a computer, such as a personal computer, an office computer, a public use computer, or the like. The first hardware device may be a telephone, such as a home or business telephone, a mobile telephone, a personal digital assistant, a two-way paging system, or the like. Moreover, service provider 104 may use a software program to generate the data key. The software program may be accessed by consumer 102 via an Internet web-site. Consumer 102 may contact a representative of service provider 104, and the representative may access the software program in response to the request for a data key. In addition, the data key be alphanumeric or may be numeric, and also may be generated randomly, sequentially, logically, or the like.

In step 204a, service provider 104 may transmit the data key to consumer 102. Moreover, service provider 104 may use a second hardware device to transmit the data key to consumer 102. The second hardware device may be a computer, such as a personal computer, an office computer, a public use computer, or the like. In another embodiment, the second hardware device may be a telephone, such as a home or business telephone, a mobile telephone, a personal digital assistant, a two-way paging system, or the like. In step 206a, service provider may transmit the data key to remote location 114. Service provider 104 also may use a third hardware device to transmit the data key to remote location 114. The third hardware device may be a computer, such as a personal computer, an office computer, a public use computer, or the like. Alternatively, the third hardware device may be a telephone, such as a home or business telephone, a mobile telephone, a personal digital assistant, a two-way paging system, or the like. In yet another embodiment, the first, second, and third hardware devices may each be the same type of device.

Remote location 114 also may store the data key transmitted by service provider 104. For example, remote location 114 may be an unattended storage device or the like. In this embodiment, the data key may be stored in a memory located inside the storage device. Alternatively, remote location 114 may be an attended location, such as an apartment complex attended by a monitor, or the like. In this embodiment, service provider 104 may transmit the data key to the monitor who then may record the transmission in a transmission log, or the like. The monitor also may transmit the data key to a memory, such as a memory of a computer or a memory of a storage device located at remote location 114, or the like.

Referring to FIG. 3A, in a further embodiment of the present invention, in step 208a, consumer 102 may conduct a commercial transaction, in which the commercial transaction may be a purchase of at least one item from a merchant 116. In this embodiment, in step 210a, after consumer 102 purchases the item from merchant 116, the data key may be transmitted to shipping agent 112. In step 212a, merchant 116 may package the item and also may transmit the package to a shipping agent 112. Merchant 116 also may generate a package identifier, which may include the data key. In this embodiment, steps 210a and 212a may be combined into a single step, and the package identifier may be affixed to the package transmitted to shipping agent 112. In step 214a, shipping agent 112 may transmit the data key to remote location 114. When remote location 114 is an unattended storage device, shipping agent 112 may use a key pad located on the storage device to manually transmit the data key to the storage device. Alternatively, shipping agent 112 may scan the data key into a data capture device and also may use the data capture device to electronically transmit the data key to the storage device. Moreover, in step 216a, shipping agent 112 may gain access to an interior of the storage device and also may transfer the package to the storage device when the transmitted data key matches the data key stored in the memory of the storage device. When remote location 114 is an attended location, in step 214a, shipping agent 112 may verbally transmit the data key to the monitor. The monitor then may compare the transmitted data key to the data key which the monitor previously received from service provider 104, and in step 216a, shipping agent 112 may transfer the package to the monitor when the transmitted data key matches the data key the monitor previously received from service provider 104.

Referring to FIG. 3B, in yet a further embodiment of the present invention, in step 208b, consumer 102 may conduct a commercial transaction, in which the commercial transaction may be a transfer of at least one item from remote location 114 to a second remote location. In this embodiment, consumer 102 previously may have transmitted the item to remote location 114. In step 210b, service provider 104 may transmit the data key to shipping agent 112. In step 212b, shipping agent 112 may transmit the data key to remote location 114. When remote location 114 is an unattended storage device, shipping agent 112 may use a key pad located on the storage device to manually transmit the data key. Alternatively, shipping agent 112 may scan the data key into a data capture device and also may use the data capture device to electronically transmit the data key to the storage device. Moreover, in step 214b, shipping agent 112 may gain access to an interior of the storage device and also may retrieve the item located inside the storage device when the transmitted data key matches the data key stored in the memory of the storage device. In step 216b, shipping agent 112 further may transfer the item from the storage device to a second remote location. When remote location 114 is an attended location, in step 212b, shipping agent 112 may verbally transmit the data key to the monitor. The monitor then may compare the transmitted data key to the data key which the monitor previously received from service provider 104, and in step 214b, shipping agent 112 may retrieve the item from the monitor when the transmitted data key matches the data key the monitor previously received from service provider 104. In step 216b shipping agent 112 further may transfer the item from the storage device to a second remote location.

Referring to FIGS. 2B, 3C, and 3D, a method 200 for conducting commercial transactions according to another embodiment of the present invention is described. In step 202b, a shipping agent 112 may generate a data key in response to a request from a consumer or user 102. Consumer 102 may use a first hardware device to request the data key. The first hardware device may be a computer, such as a personal computer, an office computer, a public use computer, or the like. In another embodiment, the first hardware device may be a telephone, such as a home or business telephone, a mobile telephone, a personal digital assistant, a two-way paging system, or the like.

A shipping agent 112 may use a software program to generate the data key. In one embodiment, the software program may be accessed by consumer 102 via an Internet web-site. In another embodiment, consumer 102 may contact a representative of a shipping agent 112 and the representative may access the software program in response to the request for a data key. Moreover, the data key be alphanumeric or may be numeric, and also may be generated randomly, sequentially, logically, or the like. In step 204b, a shipping agent 112 may transmit the data key to consumer 102. Shipping agent 112 may use a second hardware device to transmit the data key to consumer 102. The second hardware device may be a computer, such as a personal computer, an office computer, a public use computer, or the like. Alternatively, the second hardware device may be a telephone, such as a home or business telephone, a mobile telephone, a personal digital assistant, a two-way paging system, or the like.

In step 206b, shipping agent 112 may transmit the data key to remote location 114. Shipping agent 112 may use a third hardware device to transmit the data key to remote location 114. The third hardware device may be a computer, such as a personal computer, an office computer, a public use computer, or the like. Alternatively, the third hardware device may be a telephone, such as a home or business telephone, a mobile telephone, a personal digital assistant, a two-way paging system, or the like. Moreover, in an embodiment, the first, second, and third hardware devices may each be the same type of device.

Remote location 114 may store the data key transmitted by a shipping agent 112. For example, remote location 114 may be an unattended storage device or the like. In this embodiment, the data key may be stored in a memory located inside the storage device. Alternatively, remote location 114 may be an attended location, such as an apartment complex attended by a monitor, or the like. In this embodiment, a shipping agent 112 may transmit the data key to the monitor who then may record the transmission in a transmission log, or the like. The monitor also may transmit the data key to a memory, such as a memory of a computer or a memory of a storage device located at remote location 114, or the like.

Referring to FIG. 3C, in still a further embodiment of the present invention, in step 208c, consumer 102 may conduct a commercial transaction, in which the commercial transaction may be a purchase of at least one item from a merchant 116. In this embodiment, in step 212c, after consumer 102 purchases the item from merchant 116, merchant 116 may package the item and also may transmit the package to a shipping agent 112. Merchant 116 also may generate a package identifier, which may include the data key, and also may affix the package identifier to the package. In step 214c, shipping agent 112 may transmit the data key to remote location 114. When remote location 114 is an unattended storage device, shipping agent 112 may use a key pad located on the storage device to manually transmit the data key to the storage device. Alternatively, shipping agent 112 may scan the data key into a data capture device and also may use the data capture device to electronically transmit the data key to the storage device.

In step 216c, shipping agent 112 may gain access to an interior of the storage device and also may transfer the package to the storage device when the transmitted data key matches the data key stored in the memory of the storage device. When remote location 114 is an attended location, in step 214c, shipping agent 112 may verbally transmit the data key to the monitor. The monitor then may compare the transmitted data key to the data key which the monitor previously received from service provider 104, and in step 216c, shipping agent 112 may transfer the package to the monitor when the transmitted data key matches the data key the monitor previously received from service provider 104.

Referring to FIG. 3D, in yet a further embodiment of the present invention, in step 208d, consumer 102 may conduct a commercial transaction, in which the commercial transaction may be a transfer of at least one item from remote location 114 to a second remote location. In this embodiment, consumer 102 previously may have transmitted the item to remote location 114. In step 212b, shipping agent 112 may transmit the data key to remote location 114. When remote location 114 is an unattended storage device, shipping agent 112 may use a key pad located on the storage device to manually transmit the data key. Alternatively, shipping agent 112 may scan the data key into a data capture device and also may use the data capture device to electronically transmit the data key to the storage device. Moreover, in step 214d, shipping agent 112 may gain access to an interior of the storage device and also may retrieve the item located inside the storage device when the transmitted data key matches the data key stored in the memory of the storage device. In step 216d, shipping agent 112 further may transfer the item from the storage device to a second remote location. When remote location 114 is an attended location, in step 212d, shipping agent 112 may verbally transmit the data key to the monitor. The monitor then may compare the transmitted data key to the data key which the monitor previously received from service provider 104, and in step 214d, shipping agent 112 may retrieve the item from the monitor when the transmitted data key matches the data key the monitor previously received from service provider 104. In step 216d shipping agent 112 further may transfer the item from the storage device to a second remote location.

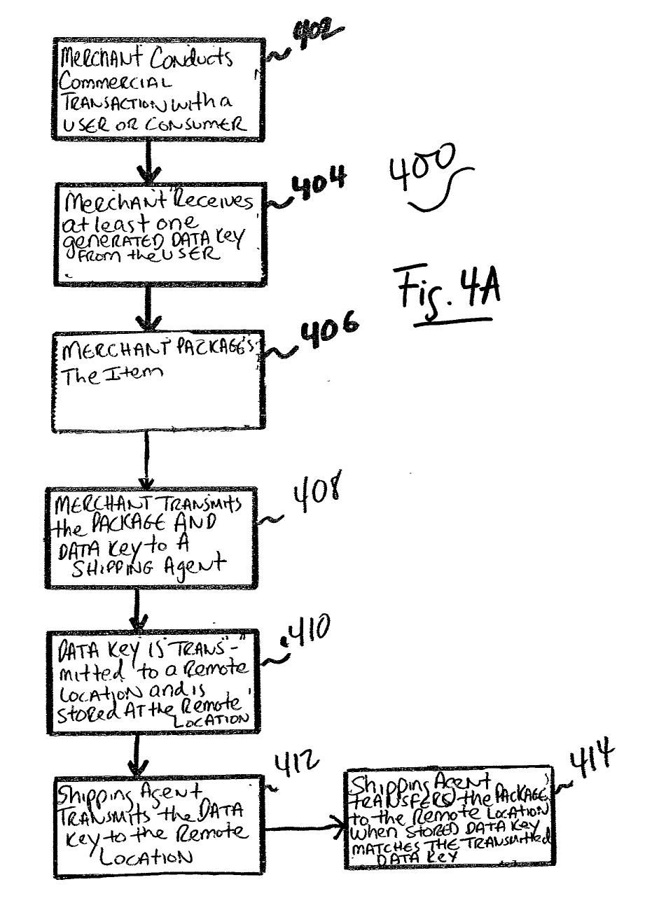

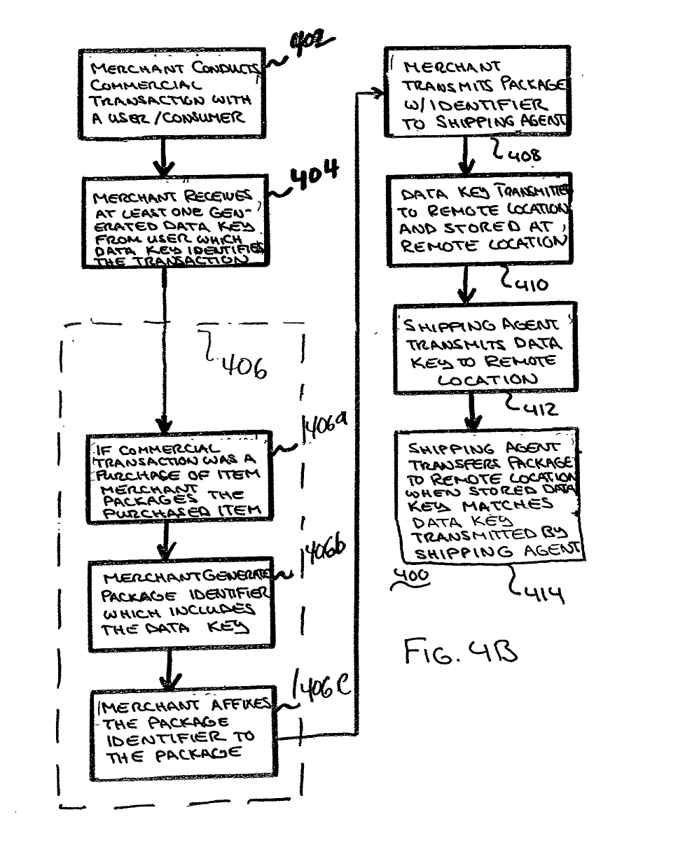

Referring to FIGS. 4A and 4B, a method 400 for conducting commercial transactions according to an embodiment of the present invention is described. The features of this embodiment are substantially similar to those features of the above-described embodiments. Therefore, the differences between this embodiment and the above-described embodiments will now be described. In step 402, a merchant 116 may conduct a commercial transaction with a consumer or a user 102. In one embodiment, the commercial transaction may be a purchase of at least one item from merchant 116. In step 404, merchant 116 may receive at least one data key from either consumer 102 or a service provider 104, in which the data key identifies the commercial transaction between merchant 116 and consumer 102. In step 406 merchant 116 may package the purchased item.

Referring to FIG. 4B, in another embodiment of the present invention, step 406 also may include steps 406a, 406b, and 406c. In step 406a, merchant 116 may package the purchased item, and in step 406b, merchant 116 may generate a package identifier, which may include the data key. In step 406c merchant 116 may affix the package identifier to the package. In each of the above described embodiments, merchant 116 further may transfer the package and the data key to a shipping agent 112. In the embodiment in which the package identifier is affixed to the package, the step of transmitting the package also may include the step of transmitting the data key. In step 410, once shipping agent 112 receives the package and the data key, shipping agent 112 may transmit the data key to a remote location 114. Moreover, in step 414, shipping agent 112 may transfer the package to remote location 114 when the transmitted data key matches a data key which previously was stored at remote location 114. For example, service provider 104 previously may have transmitted the data key to remote location 114 and the data key may have been stored in a memory, such as a memory in an unattended storage device or a memory in a computer system located at remote location 114, or the like.

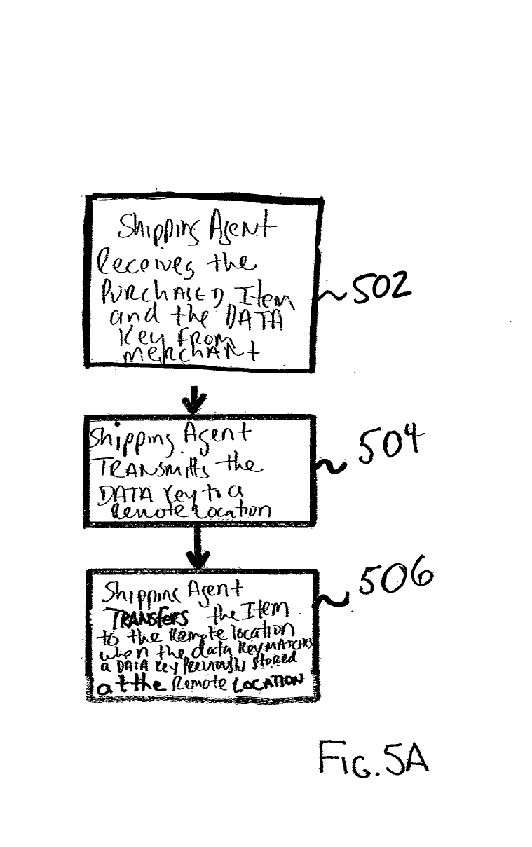

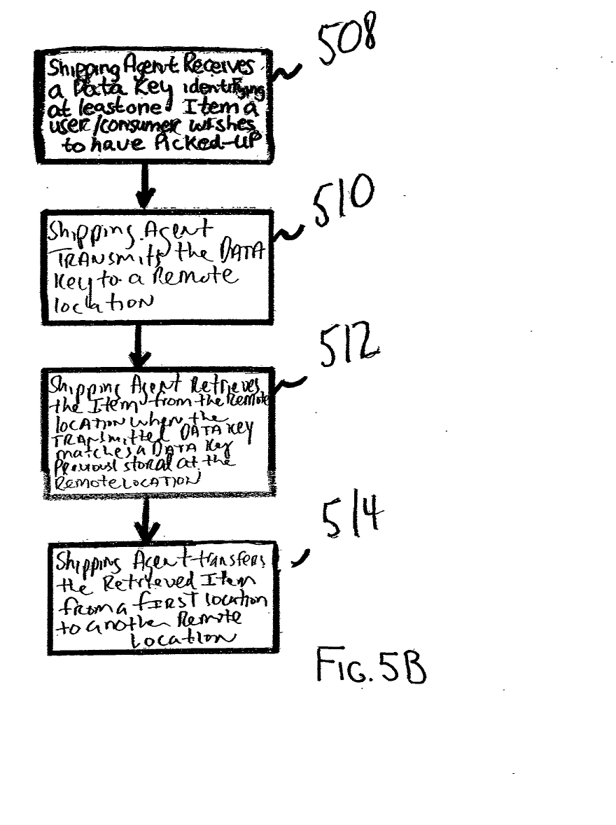

Referring to FIG. 5A, a method 500a for conducting commercial transactions according to an embodiment of the present invention is described. The features of this embodiment are substantially similar to those features of the above-described embodiments. Therefore, the differences between this embodiment and the above-described embodiments will now be described. Prior to an implementation of a method 500a, a consumer or a user 102 may request that a service provider 104 generate a data key. Service provider 104 may generate the data key and also may transmit the data key to consumer 102. Consumer 102 also may purchase at least one item from a merchant 116, in which the data key may identify the purchased item. In step 502, a shipping agent 112 may receive the purchased item and the data key from merchant 116. In one embodiment, a package identifier, which may include the data key, may be generated by the merchant and also may be affixed to the package transmitted to shipping agent 104. In step 504, shipping agent 504 may transmit the data key to a remote location. Moreover, in step 506, shipping agent 112 may transfer the package to remote location 114 when the transmitted data key matches a data key which previously was stored at remote location 114. For example, service provider 104 previously may have transmitted the data key to remote location 114 and the data key may have been stored in a memory, such as a memory in an unattended storage device or a memory in a computer system located at remote location 114, or the like.

Referring to FIG. 5B, method 500b for conducting commercial transactions according to an embodiment of the present invention is described. The features of this embodiment also are substantially similar to those features of the above-described embodiments. Therefore, the differences between this embodiment and the above-described embodiments will now be described. Prior to an implementation of a method 500b, a consumer or a user 102 may transmit an item to a remote location 114 so that the item may be shipped from remote location 114 to a second remote location. To facilitate pick-up and transfer of the item, consumer 102 may request that a service provider 104 generate a data key. In this embodiment, in step 508, a shipping agent 112 may receive the data key from service provider 104, in which the data key may identify the item for pick-up. In step 510, shipping agent 112 may transmit the data key to remote location 114. Moreover, in step 512, shipping agent 112 may retrieve the item from remote location 114 when the transmitted data key matches a data key which previously was stored at remote location 114. For example, service provider 104 previously may have transmitted the data key to remote location 114 and the data key may have been stored in a memory, such as a memory in an unattended storage device or a memory in a computer system located at remote location 114, or the like. In step 514, shipping agent 112 may transfer the item from remote location 114 to a second remote location.

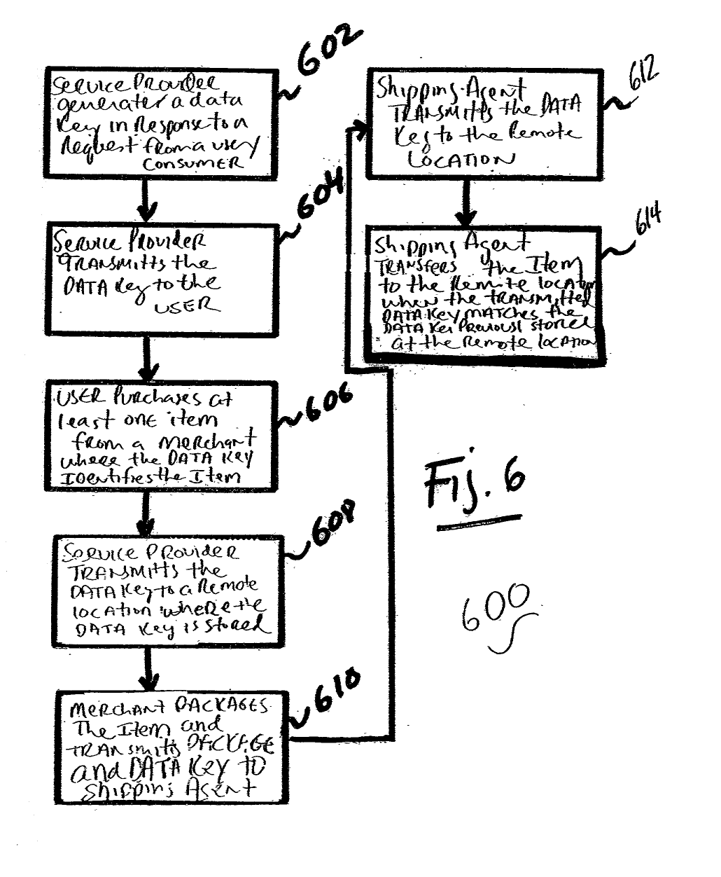

Referring to FIG. 6, a method 600 for conducting commercial transactions according to an embodiment of the present invention is described. The features of this embodiment are substantially similar to those features of the above-described embodiments. Therefore, the differences between this embodiment and the above-described embodiments will now be described. In step 602, a service provider 104 may generate a data key in response to a request from a consumer or a user 102. In step 604, service provider 104 may transmit the data key to consumer 102. In step 606, consumer 102 may purchase at least one item from a merchant 116 and also may transmit the data key to merchant 116, in which the data key may identify the purchased item. In step 608, the service provider may transmit the data key to a remote location 114 and the data key may be stored at remote location 114. In step 610, merchant 116 may package the item and also may transfer the package and the data key to a shipping agent 112. In one embodiment, merchant 116 may generate a package identifier, which may include the data key, and also may affix the package identifier to the package. In step 612, shipping agent 112 may transmit the data key to remote location 114. Moreover, in step 614, shipping agent 112 may transfer the package to remote location 114 when the transmitted data key matches the data key stored at remote location 114.

While the invention has been described in connecting with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein.

What is claimed is:

1. A method for conducting commercial transactions comprising the steps of:
generating a data key in response to a request from at least one user;
transmitting said data key to said user; and
transmitting said data key to a first remote location, wherein said data key identifies at least one commercial transaction conducted by said user and is stored at said first remote location.

2. The method of claim 1, wherein a software program generates said data key.

3. The method of claim 2, wherein said software program is provided via an Internet web-site.

4. The method of claim 2, wherein said software program is accessed using a hardware device.

5. The method of claim 4, wherein said hardware device is at least one device selected from the group consisting of: a computer, a telephone, a personal digital assistant, and a two-way paging device.

6. The method of claim 5, wherein said data key is either randomly, logically, or sequentially generated by said software program.

7. The method of claim 5, wherein said data key is transmitted to said user via said hardware device.

8. The method of claim 4, wherein said commercial transaction is a purchase of at least one item from at least one merchant.

9. The method of claim 8, further comprising the step of transmitting said data key to a shipping agent.

10. The method of claim 9, further comprising the steps of:
receiving said purchased item from said merchant;
transmitting said data key to said first remote location; and
transferring said purchased item to said first remote location when said transmitted data key matches said stored data key.

11. The method of claim 10, wherein said first remote location is an unattended storage device and said data key is stored in a memory of said unattended storage device.

12. The method of claim 4, wherein said first remote location is an unattended storage device and said data key is stored in a memory of said unattended storage device.

13. The method of claim 12, wherein said commercial transaction is a transferring of at least one item from said unattended storage device to at least one second remote location.

14. The method of claim 13, further comprising the step of transmitting said data key to a shipping agent.

15. The method of claim 14, further comprising the steps of:
transmitting said data key to said unattended storage device;
retrieving said item from said unattended storage device when said transmitted data key matches said data key stored in said memory; and
transferring said item to said second remote location.

16. The method of claim 9, further comprising the steps of:
receiving said purchased item from said merchant;
transmitting said data key to said first remote location; and
transferring said purchased item to said first remote location when said transmitted data key matches said stored data key.

17. The method of claim 16, wherein said first remote location is an unattended storage device and said data key is stored in a memory of said unattended storage device.

18. The method of claim 13, further comprising the steps of:
transmitting said data key to said unattended storage device;
retrieving said item from said unattended storage device when said transmitted data key matches said data key stored in said memory; and
transferring said item to said second remote location.

19. A method for conducting commercial transactions comprising the steps of:
conducting at least one commercial transaction with a user;
receiving at least one generated data key from said user, wherein said data key identifies said commercial transaction; and
transmitting said data key to a shipping agent.

20. The method of claim 19, wherein said data key is generated by a software program.

21. The method of claim 20, wherein said software program is provided via an Internet web-site.

22. The method of claim 20, wherein said software program is accessed using a hardware device.

23. The method of claim 22, wherein said hardware device is at least one device selected from the group consisting of: a computer, a telephone, a personal digital assistant, and a two-way paging device.

24. The method of claim 23, wherein said data key is either randomly, logically, or sequentially generated by said software program.

25. The method of claim 23, wherein said user receives said data key via said hardware device.

26. The method of claim 22, wherein said commercial transaction is a purchase of at least one item.

27. The method claim 26, wherein said purchase of said item is from a remote location.

28. The method of claim 26, further comprising the steps of:
packaging said purchased item;
generating a package identifier, wherein said package identifier comprises said data key;
affixing said package identifier to said package; and
transferring said package to a shipping company.

29. The method of claim 28, further comprising the steps of:
transmitting said data key to said first remote location; and
transferring said package to said first remote location when said transmitted data key matches a data key previously stored at said remote location.

30. The method of claim 29, wherein said first remote location is an unattended storage device and said data key is stored in a memory of said unattended storage device.

31. A method for conducting commercial transactions comprising the steps of:
receiving at least one data key identifying at least one item purchased by a user;
receiving said item purchased by said user;
transmitting said data key to a first remote location; and
transferring said item to said remote location when said data key matches a data key previously stored at said first remote location.

32. The method of claim 31, wherein said data key is generated by a software program.

33. The method of claim 32, wherein said software program is provided via an Internet web-site.

34. The method of claim 32, wherein said software program is accessed using a hardware device.

35. The method of claim 34, wherein said hardware device is at least one device selected from the group consisting of: a computer, a telephone, a personal digital assistant, and a two-way paging device.

36. The method of claim 35, wherein said data key is either randomly, logically, or sequentially generated by said software program.

37. The method of claim 35, wherein said user receives said data key via said hardware device.

38. The method of claim 34, further comprising the steps of:
packaging said purchased item;
generating a package identifier, wherein said package identifier comprises said data key; and
affixing said package identifier to said package.

39. The method of claim 38, wherein said first location is an unattended storage device and said data key is stored in a memory of said unattended storage device.

40. The method of claim 38, wherein said package is purchased by said user from a remote location.

41. A method for conducting commercial transactions comprising the steps of:
receiving at least one data key, wherein said data key identifies at least one item for pick-up requested by a user;
transmitting said first data key to a first remote location;
retrieving said item when said data key matches a data key previously stored at said first remote location; and
transferring said item from said first location to a second location.

42. The method of claim 41, wherein said data key is generated by a software program.

43. The method of claim 42, wherein said software program is provided via an Internet web-site.

44. The method of claim 42, wherein said software program is accessed using a hardware device.

45. The method of claim 44, wherein said hardware device is at least one device selected from the group consisting of: a computer, a telephone, a personal digital assistant, and a two-way paging device.

46. The method of claim 45, wherein said data key is either randomly, logically, or sequentially generated by said software program.

47. The method of claim 45, wherein said user receives said data key via said hardware device.

48. The method of claim 38, wherein said first location is an unattended storage device and said data key is stored in a memory of said unattended storage device.

49. A method for conducting commercial transactions comprising the steps of:
generating a data key in response to a request from at least one user;
transmitting said data key to said user;
purchasing at least one item, wherein said data key identifies said item;
transmitting said data key and transferring said item to a shipping agent;
transmitting and storing said data key at a remote location;
transmitting said data key to said remote location; and
transferring said item to said remote location when said data key matches said data key stored at said remote location.

50. A system for conducting commercial transactions comprising:
means for generating a data key in response to a request from at least one user;
means for transmitting said data key to said user;
a first means for transmitting said data key to a first remote location; and
means for storing said transmitted data key at said first remote location, wherein said data key identifies at least one commercial transaction conducted by said user.

51. The system of claim 50, wherein said means for generating said data key is a software program

52. The system of claim 51, wherein said software program is provided via an Internet web-site.

53. The system of claim 51, wherein said means for transmitting said data key to said user is a first hardware device and said first hardware device is at least one device selected from the group consisting of: a computer, a telephone, a personal digital assistant, and a two-way paging device.

54. The system of claim 53, wherein said first means for transmitting said data key to said first remote location is a second hardware device and said means for storing said transmitted data key is a memory.

55. The system of claim 54, wherein said second hardware device is at least one device selected from the group consisting of: a computer, a telephone, a personal digital assistant, and a two-way paging device.

56. The system of claim 55, wherein said data key is either randomly, logically, or sequentially generated by said software program.

57. The system of claim 55, wherein said commercial transaction is a purchase of at least one item from at least one merchant.

58. The system of claim 57, further comprising means for transmitting said data key to a shipping agent.

59. The system of claim 58, wherein said means for transmitting said data key to said shipping agent is a third hardware device, wherein said third hardware device is at least one device selected from the group consisting of: a computer, a telephone, a personal digital assistant, and a two-way paging device.

60. The system of claim 59, further comprising:
means for receiving said purchased item from said merchant; and
a second means for transmitting said data key to said first remote location, wherein said purchased item is transferred to said first remote location when said transmitted data key matches said stored data key.

61. The system of claim 60, wherein said first remote location is an unattended storage device and said data key is stored in a memory of said unattended storage device.

62. The system of claim 61, wherein said second means for transmitting said data key to said first location is either a key pad, wherein said data key is entered by pressing at least one key on said key pad, or a data capture device, wherein said data key is scanned into said data capture device and electronically transmitted to said first location.

63. The system of claim 55, wherein said commercial transaction is a transfer of at least one item from said first remote location to at least one second remote location and said first remote location is an unattended storage device.

64. The system of claim 63, further comprising:
means for transmitting said data key to a shipping agent; and
a second means for transmitting said data key to said unattended storage device, wherein said item is retrieved from said unattended storage device and transferred to said second remote location when said transmitted data key matches said data key stored in said memory.

65. The system of claim 64, wherein said second means for transmitting said data key to said unattended storage device is either a key pad, wherein said data key is entered by pressing at least one key on said key pad, or a data capture device, wherein said data key is scanned into said data capture device and electronically transmitted to said unattended storage device.

66. The system of claim 57, further comprising:
means for receiving said purchased item from said merchant; and
a second means for transmitting said data key to said first remote location, wherein said purchased item is transferred to said first remote location when said transmitted data key matches said stored data key.

67. The system of claim 66, wherein said first remote location is an unattended storage device and said data key is stored in a memory of said unattended storage device.

68. The system of claim 67, wherein said second means for transmitting said data key to said first location is either a key pad, wherein said data key is entered by pressing at least one key on said key pad, or a data capture device, wherein said data key is scanned into said data capture device and electronically transmitted to said first location.

69. The system of claim 63, further comprising:
a second means for transmitting said data key to said unattended storage device, wherein said item is retrieved from said unattended storage device and transferred to said second remote location when said transmitted data key matches said data key stored in said memory.

70. The system of claim 64, wherein said second means for transmitting said data key to said unattended storage device is either a key pad, wherein said data key is entered by pressing at least one key on said key pad, or a data capture device, wherein said data key is scanned into said data capture device and electronically transmitted to said unattended storage device.
